(19) United States
(12) Patent Application Publication
(10) Pub. No.: US 2016/0153393 A1
(43) Pub. Date: Jun. 2, 2016

(54) ALUMINUM MONOBLOCK ENGINE USING INTERBORE CONCENTRATION FLUX SUPPLY TYPE WATER JACKET

(71) Applicant: Hyundai Motor Company, Seoul (KR)

(72) Inventors: Jong-Hyuck KIM, Suwon-si (KR); Eun-Ho Lee, Suwon-si (KR)

(73) Assignee: Hyundai Motor Company, Seoul (KR)

(21) Appl. No.: 14/788,387

(22) Filed: Jun. 30, 2015

(30) Foreign Application Priority Data
Dec. 1, 2014 (KR) 10-2014-0169653

(51) Int. Cl. F02F 1/16; F02F 7/00; B22D 21/00; F02F 1/00; B22C 1/00; B22D 25/02

(52) U.S. Cl. CPC F02F 1/16; B22C 1/00; B22D 25/02; B22D 21/007; F02F 1/004; F02F 7/0085

(57) ABSTRACT

An aluminum monoblock having an interbore concentration flux supply type water jacket may include a plurality of Fe-coated liners configured to be continuously formed by coating Fe on an aluminum surface of the aluminum monoblock and a plurality of interbore cooling water paths configured to divide the Fe-coated liners and to individually circulate engine cooling water introduced to side surfaces of the plurality of Fe-coated liners.

### CROSS-REFERENCE TO RELATED APPLICATIONS

The present application claims priority of Korean Patent Application Number 10-2014-0169653 filed on Dec. 1, 2014, the entire contents of which application are incorporated herein for all purposes by this reference.

### BACKGROUND OF INVENTION

1. Field of Invention

The present invention relates to an aluminum monoblock engine, and, more particularly, to an aluminum monoblock engine using an interbore concentration flux supply type water jacket, which is suitable for downsizing of an engine by removing a liner made of heavy cast iron, and can enhance the cooling performance of the engine and improve the fuel efficiency and performance.

2. Description of Related Art

The aluminum block engine technology for a vehicle is a technology suitable for an engine which shows a tendency of downsizing by applying a turbocharger, and enables a small and light engine to be implemented to meet the technology flow to engine downsizing.

Generally, two types of water jackets are applied to the aluminum block engine.

One is implemented by a cast iron liner scheme with which a water jacket is integrated, and the other is implemented by a wet liner scheme using a wet liner water jacket in which a wet liner is connected.

However, according to the cast iron liner scheme, since a cast iron liner is inserted into an aluminum block engine, the availability of space in a bore pitch is reduced, so that it is inevitable to form water jacket holes which are drilled in the cross-drilling method. For this reason, although the interbore part may be cooled through the water jacket holes, the amount of engine cooling water flowing therethrough is too small to achieve sufficient cooling.

In addition, according to the wet liner scheme, the inside of a block is dug, and a separately manufactured liner is inserted thereinto, so that cooling can been enhanced due to a cross flow configuration. However, in this case, there is difficulty in sealing the portion between the block and a head, so that sealing may be deteriorated due to transformation of the block and head caused on an engine operation.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention is directed to an aluminum monoblock engine having an interbore concentration flux supply type water jacket, which is configured to concentrate engine cooling water, introduced through a cooling water inflow path, to interbore cooling water paths provided between Fe-coated liners, so that the cooling performance of the interbore is enhanced and the paths between liners is reduced due to a sufficient amount of cooling water, thereby ensuring an aluminum portion having a thickness of 10 mm or more in a bore pitch.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with various aspects of the present invention, an aluminum monoblock having an interbore concentration flux supply type water jacket includes: a plurality of Fe-coated liners configured to be continuously formed by coating Fe on an aluminum surface of the aluminum monoblock; and a plurality of interbore cooling water paths configured to divide the Fe-coated liners and to individually circulate engine cooling water introduced to side surfaces of the plurality of Fe-coated liners.

A cooling water inflow path may be provided on the side surfaces of the plurality of Fe-coated liners, and may be configured for the engine cooling water to flow in and to flow out to the plurality of interbore cooling water paths. The cooling water inflow path may include: a cooling water introduction pipe configured for the engine cooling water to be introduced therethrough; and a plurality of cooling water supply flow paths configured to be connected to the interbore cooling water paths and to enable the engine cooling water, which has passed through the cooling water introduction pipe, to flow therethrough. The plurality of cooling water supply flow paths may be configured to be connected to the plurality of Fe-coated liners and to enable the engine cooling water to flow to the plurality of Fe-coated liners.

Each of the plurality of Fe-coated liners may be configured to have a plurality of head cooling water paths formed thereon, and the plurality of head cooling water paths may be configured to be connected to the plurality of cooling water supply flow paths.

In accordance with various other aspects of the present invention, an aluminum monoblock engine includes an aluminum monoblock, which includes: a cooling water inflow path provided on side surfaces of first, second, third and fourth Fe-coated liners which are formed by coating Fe on aluminum surfaces of the aluminum monoblock, and configured to enable engine cooling water to be introduced therethrough; first, second and third interbore cooling water paths configured to divide the first, second, third and fourth Fe-coated liners and to individually circulate the engine cooling water which is introduced through the cooling water inflow path; and first and second head cooling water paths configured to enable the engine cooling water, which is introduced through the cooling water inflow path, to flow to a cylinder head.

The aluminum monoblock may include aluminum portions dividing the first, second, third and fourth Fe-coated liners and having a thickness of 10 mm or more, wherein the first, second and third interbore cooling water paths are formed in the aluminum portions. The aluminum monoblock may be manufactured by a precision sand gravity casting using a zirconium sand mold.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating the configuration of an aluminum monoblock to which an interbore concentration flux supply type water jacket having a Fe-coated liner is applied in accordance with an embodiment of the present invention;

FIG. 2A is a view illustrating the configuration of a part of an engine configured with an aluminum monoblock to which an interbore concentration flux supply type water jacket having a Fe-coated liner is applied in accordance with an embodiment of the present invention;

FIG. 2B is a perspective view of FIG. 2A taken along line A-A; and

FIG. 3 is a view illustrating an example in which a more improved cooling performance is implemented by an interbore concentration flux supply type water jacket having a Fe-coated liner in an aluminum monoblock engine in accordance with an embodiment of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

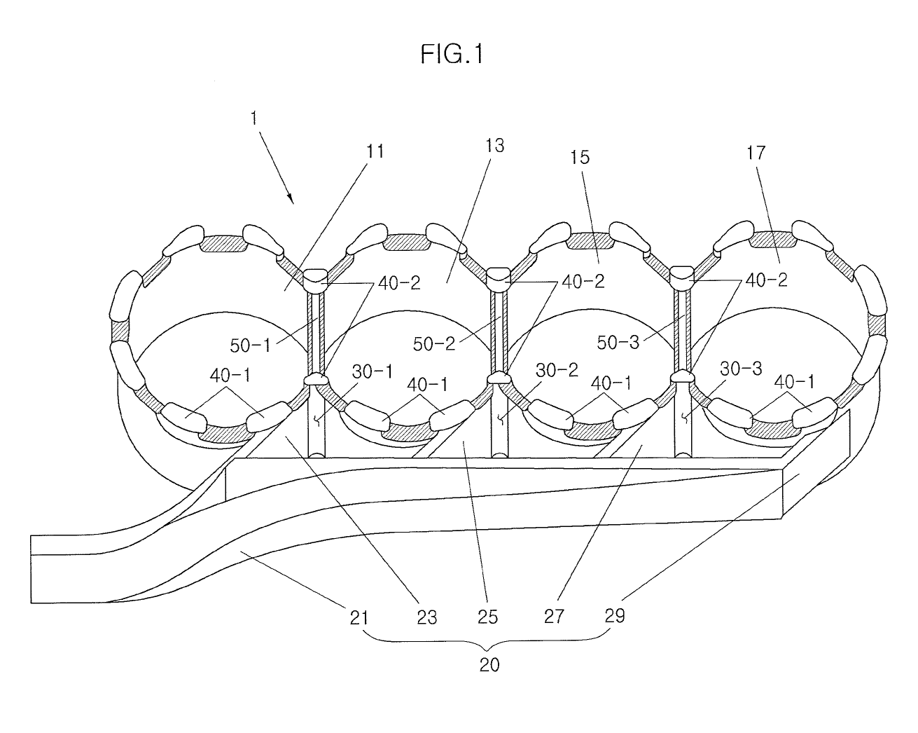

FIG. 1 is a view illustrating the configuration of an aluminum monoblock to which an interbore concentration flux supply type water jacket having a Fe-coated liner is applied in accordance with an embodiment of the present invention. As illustrated in FIG. 1, the aluminum monoblock includes a block water jacket 1, wherein the block water jacket 1 includes a plurality of interbore cooling water paths 50-1, 50-2 and 50-3 and a plurality of head cooling water paths 40-1 and 40-2, which are connected to a plurality of Fe-coated liners 11, 13, 15 and 17 forming the boar of a cylinder block. In addition, the block water jacket 1 includes a cooling water inflow path 20 configured to concentrate engine cooling water to the plurality of Fe-coated liners 11, 13, 15 and 17.

As an example, in the case of a four-cylinder engine, the plurality of Fe-coated liners 11, 13, 15 and 17 is constituted by first, second, third and fourth Fe-coated liners 11, 13, 15 and 17, respectively. Therefore, the plurality of Fe-coated liners 11, 13, 15 and 17 varies depending on the number of cylinders of an engine.

In some embodiments, the plurality of head cooling water paths 40-1 and 40-2 are divided into a first head cooling water path 40-1 and a second head cooling water path 40-2. The first head cooling water path 40-1 is formed in the surroundings of the first, second, third and fourth Fe-coated liners 11, 13, 15 and 17, while the second head cooling water path 40-2 is formed to be adjacent to each of the plurality of interbore cooling water paths 50-1, 50-2 and 50-3. Therefore, each of the first and second head cooling water paths 40-1 and 40-2 functions as a path to elevate the engine cooling water, which has cooled the first, second, third and fourth Fe-coated liners 11, 13, 15 and 17, to each corresponding cylinder head. In contrast, the first and second head cooling water paths 40-1 and 40-2 do not function to close a hole with a head gasket through selective selection considering the amount of water for cooling, and to send all the engine cooling water to the cylinder head by tuning of the sizes of the cooling water path holes of the cylinder head.

In some embodiments, the plurality of interbore cooling water paths 50-1, 50-2 and 50-3 is accorded to the number of the Fe-coated liners 11, 13, 15 and 17, so that the first, second and third interbore cooling water paths 50-1, 50-2 and 50-3 are applied to the first, second, third and fourth Fe-coated liners 11, 13, 15 and 17.

For example, the first interbore cooling water path 50-1 may be formed in an interbore which partitions the first Fe-coated liner 11 and the second Fe-coated liner 13 from each other, the second interbore cooling water path 50-2 may be formed in an interbore which partitions the second Fe-coated liner 13 and the third Fe-coated liner 15 from each other, and the third interbore cooling water path 50-3 may be formed in an interbore which partitions the third Fe-coated liner 15 and the fourth Fe-coated liner 17 from each other. Therefore, each of the first, second and third interbore cooling water paths 50-1, 50-2 and 50-3 can circulate the engine cooling water along the surroundings of the first, second, third and fourth Fe-coated liners 11, 13, 15 and 17.

In some embodiments, the cooling water inflow path 20 is divided into a cooling water introduction pipe 21 and cooling water supply flow paths 23, 25, 27 and 29, wherein the cooling water supply flow paths 23, 25, 27 and 29 are accorded to the number of the first, second, third and fourth Fe-coated liners 11, 13, 15 and 17, so that the cooling water supply flow paths 23, 25, 27 and 29 are applied to the first, second, third and fourth Fe-coated liners 11, 13, 15 and 17.

For example, the cooling water introduction pipe 21 may be located at one-side portion of the first, second, third and fourth Fe-coated liners 11, 13, 15 and 17 so as to introduce the engine cooling water to the engine cooling water flow path of the cylinder block. The first cooling water supply flow path 23 may be connected to the first Fe-coated liner 11 and the first interbore cooling water path 50-1, the second cooling water supply flow path 25 may be connected to the second Fe-coated liner 13 and the second interbore cooling water path 50-2, the third cooling water supply flow path 27 may be connected to the third Fe-coated liner 15 and the third interbore cooling water path 50-3, and the fourth cooling water supply flow path 29 may be connected to the fourth Fe-coated liner 17.

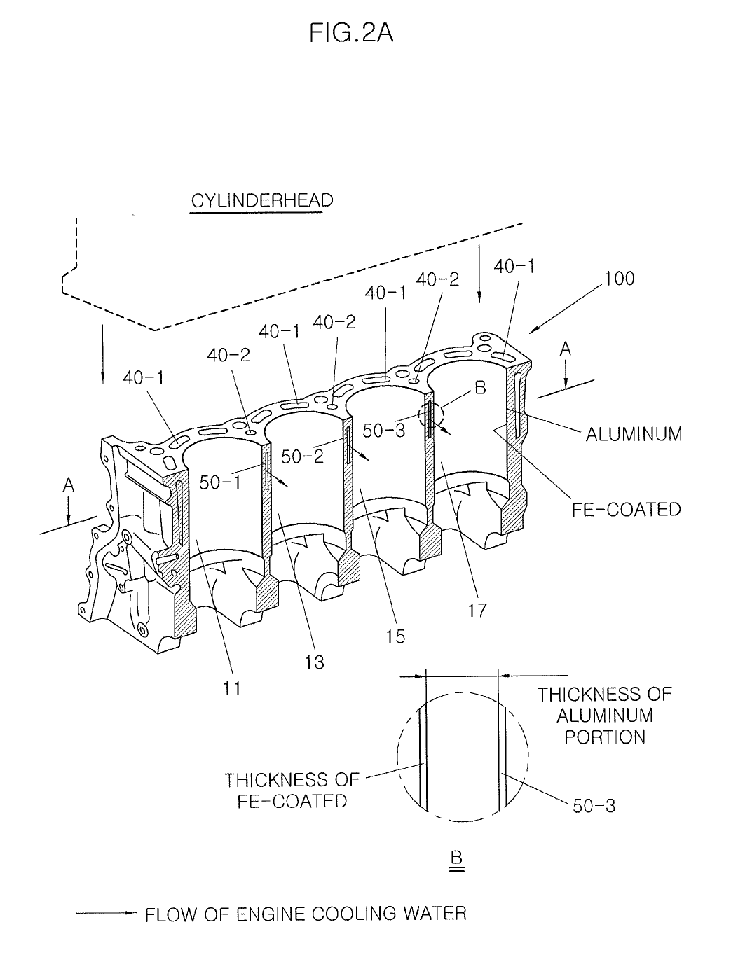

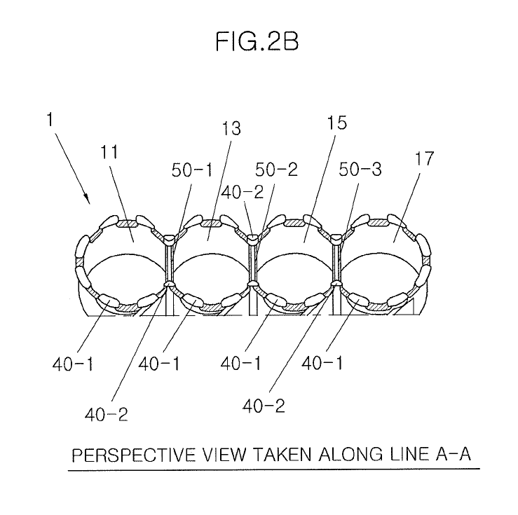

Meanwhile, FIGS. 2A and 2B show an example in which an aluminum monoblock 100 having the block water jacket 1 is applied to an engine. As shown in FIGS. 2A and 2B, an aluminum monoblock engine includes an aluminum monoblock 100 configured to form four bores by the first, second, third and fourth Fe-coated liners 11, 13, 15 and 17, wherein the aluminum monoblock 100 includes a block water jacket 1.

Especially, the block water jacket 1 is constituted by a cooling water inflow path 20, head cooling water paths 40-1 and 40-2, and first, second and third interbore cooling water paths 50-1, 50-2 and 50-3, which are described with reference to FIG. 1. Accordingly, the aluminum monoblock 100 has an improved structure and performance according to a cooling efficiency which is improved by the first, second and third interbore cooling water paths 50-1, 50-2 and 50-3.

In view of structure, the aluminum monoblock 100 does not require to form a water jacket hole on an interbore part by a cross-drilling method, which has been required on the conventional cast iron liner, so that an aluminum portion having a thickness of about 10 mm or more can be ensured because the thickness of a cast iron liner, which is 5 mm, is not taken into considered in a bore pitch.

In view of cooling performance, since Fe coating or the like is applied to the aluminum surface of the aluminum monoblock 100, the aluminum monoblock 100 has a heat conductivity two times higher than the conventional cast iron liner, thereby maximizing the cooling efficiency of the liner-integrated water jacket 1.

In view of manufacturing method, the aluminum monoblock 100 is manufactured by a precision sand gravity casting method using a zirconium sand mold, thereby improving the illumination in the inside of the water jacket.

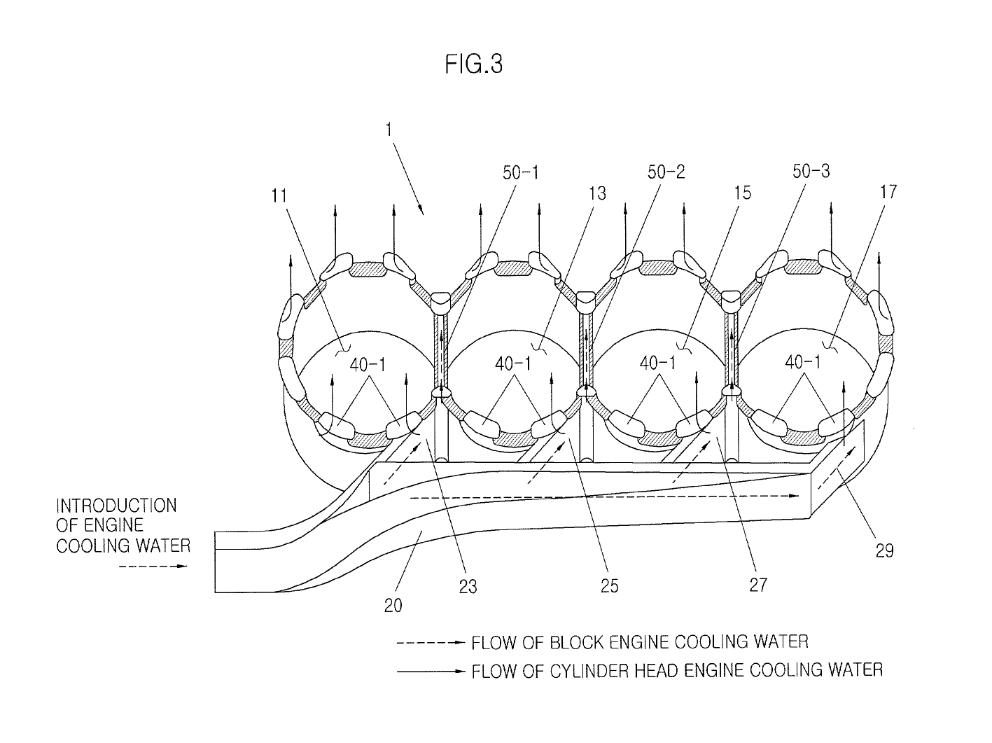

Meanwhile, FIG. 3 shows a distribution of flow of engine cooling water in a liner-integrated water jacket 1 which is applied to an aluminum monoblock engine.

As shown in FIG. 3, engine cooling water supplied from an engine cooling water flow path of the aluminum monoblock 100 to the cooling water inflow path 20 flows through the cooling water introduction pipe 21 and are distributed to the respective cooling water supply flow paths 23, 25, 27 and 29. Then, engine cooling water which has passed through the first cooling water supply flow path 23 first naturally flows into the first interbore cooling water path 50-1, and simultaneously, the remaining flux thereof flows into each of the first and second head cooling water paths 40-1 and 40-2 by flow inertia. Engine cooling water which has passed through the second cooling water supply flow path 25 first naturally flows into the second interbore cooling water path 50-2, and simultaneously, the remaining flux thereof flows into each of the first and second head cooling water paths 40-1 and 40-2 by flow inertia. Engine cooling water which has passed through the third cooling water supply flow path 27 first naturally flows into the third interbore cooling water path 50-3, and simultaneously, the remaining flux thereof flows into each of the first and second head cooling water paths 40-1 and 40-2 by flow inertia. In addition, engine cooling water which has passed through the fourth cooling water supply flow path 29 naturally flows into each of the first and second head cooling water paths 40-1 and 40-2.

In this case, engine cooling water which has flowed into each of the first and second head cooling water paths 40-1 and 40-2 is met in the aluminum monoblock 100, and then either is all sent to the cylinder head constituting the aluminum monoblock engine, or only partially sent to the cylinder head due to blocking by a head gasket or due to the sizes of the cooling water path holes of the cylinder head.

As the result of a test, it was confirmed, because of especially the concentrative engine cooling water flow to the interbore by the first, second and third interbore cooling water paths 50-1, 50-2 and 50-3, in addition to flow of engine cooling water by the first, second, third and fourth cooling water supply flow paths 23, 25, 27 and 29 and first and second head cooling water paths 40-1 and 40-2, the engine having the aluminum monoblock 100 achieves a temperature drop by about 10 degrees as compared with the conventional engine having an aluminum monoblock to which a cast iron liner is applied, and particularly, achieves a temperature drop by about 20 degrees as compared with the conventional aluminum monoblock engine to which a wet liner is applied.

As described above, according to the aluminum monoblock engine having an interbore concentration flux supply type water jacket in accordance with an embodiment of the present invention, the aluminum monoblock 100 having the first, second and third interbore cooling water paths 50-1, 50-2 and 50-3 partitioning the continued first, second, third and fourth Fe-coated liners 11, 13, 15 and 17 with the same number as that of bores is configured. Thus, engine cooling water flowing from the engine cooling water flow path into the cooling water inflow path 20 provided on the side surfaces of the first, second, third and fourth Fe-coated liners 11, 13, 15 and 17 can be sufficiently supplied to the interbore. Especially, the sufficient amount of cooling water enhances the cooling performance of the interbore, enables reduction of the paths between the first, second, third and fourth Fe-coated liners 11, 13, 15 and 17, and enables an aluminum portion having a thickness of 10 mm or more to be ensured in a bore pitch.

In accordance with the exemplary embodiments of the present invention, the aluminum monoblock engine having an interbore concentration flux supply type water jacket is configured with a water jacket having a Fe-coated liner, and thus has advantages as follows. First, the cooling of the interbore part is enhanced to improve the anti-knocking property, so that the fuel efficiency and performance is improved. Secondly, there is no leak problem and the stability is improved as compared with the conventional wet liner scheme. Thirdly, a separate linear is not required, so that the production cost is reduced. Fourthly, the weight of the block is reduced because the conventional cast iron liner is removed.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An aluminum monoblock having an interbore concentration flux supply type water jacket, comprising:
a plurality of Fe-coated liners configured to be continuously formed by coating Fe on an aluminum surface of the aluminum monoblock; and
a plurality of interbore cooling water paths configured to divide the Fe-coated liners and to individually circulate engine cooling water introduced to side surfaces of the plurality of Fe-coated liners.

2. The aluminum monoblock of claim 1, wherein a cooling water inflow path is provided on the side surfaces of the plurality of Fe-coated liners, and is configured for the engine cooling water to flow in and to flow out to the plurality of interbore cooling water paths.

3. The aluminum monoblock of claim 2, wherein the cooling water inflow path comprises:
a cooling water introduction pipe configured for the engine cooling water to be introduced therethrough; and
a plurality of cooling water supply flow paths configured to be connected to the interbore cooling water paths and to enable the engine cooling water, which has passed through the cooling water introduction pipe, to flow therethrough.

4. The aluminum monoblock of claim 3, wherein the plurality of cooling water supply flow paths are configured to be connected to the plurality of Fe-coated liners and to enable the engine cooling water to flow to the plurality of Fe-coated liners.

5. The aluminum monoblock of claim 4, wherein each of the plurality of Fe-coated liners is configured to have a plurality of head cooling water paths formed thereon, and the plurality of head cooling water paths are configured to be connected to the plurality of cooling water supply flow paths.

6. An aluminum monoblock engine comprising:
an aluminum monoblock, wherein the aluminum monoblock comprises:
a cooling water inflow path provided on side surfaces of first, second, third and fourth Fe-coated liners which are formed by coating Fe on aluminum surfaces of the aluminum monoblock, and configured to enable engine cooling water to be introduced therethrough;
first, second and third interbore cooling water paths configured to divide the first, second, third and fourth Fe-coated liners and to individually circulate the engine cooling water which is introduced through the cooling water inflow path; and
first and second head cooling water paths configured to enable the engine cooling water, which is introduced through the cooling water inflow path, to flow to a cylinder head.

7. The aluminum monoblock engine of claim 6, wherein the aluminum monoblock includes aluminum portions dividing the first, second, third and fourth Fe-coated liners and having a thickness of 10 mm or more, wherein the first, second and third interbore cooling water paths are formed in the aluminum portions.

8. The aluminum monoblock engine of claim 6, wherein the aluminum monoblock is manufactured by a precision sand gravity casting using a zirconium sand mold.
